(19) United States
(12) Patent Application Publication
(10) Pub. No.: US 2021/0057716 A1
(43) Pub. Date: Feb. 25, 2021

(54) POSITIVE ACTIVE MATERIAL, POSITIVE ELECTRODE, NONAQUEOUS ELECTROLYTE ENERGY STORAGE DEVICE, METHOD OF PRODUCING POSITIVE ACTIVE MATERIAL, METHOD OF PRODUCING POSITIVE ELECTRODE, AND METHOD OF PRODUCING NONAQUEOUS ELECTROLYTE ENERGY STORAGE DEVICE

(71) Applicant: GS Yuasa International Ltd., Kyoto-shi, Kyoto (JP)

(72) Inventor: Yusuke MIZUNO, Kyoto (JP)

(21) Appl. No.: 16/967,159

(22) PCT Filed: Feb. 1, 2019
(86) PCT No.: PCT/JP2019/003543

§ 371 Date: Aug. 4, 2020

(30) Foreign Application Priority Data
Feb. 20, 2018 (JP) 2018-027954

(51) Int. Cl. H01M 4/131; H01M 4/134; H01M 4/525; H01M 4/505; H01M 4/36; H01M 10/0525; C01G 53/00

(52) U.S. Cl. CPC H01M 4/131; H01M 4/134; H01M 4/525; H01M 2004/028; H01M 4/364; H01M 10/0525; C01G 53/50; H01M 4/505

(57) ABSTRACT

One aspect of the present invention is a positive active material (I) containing an oxide represented by the following formula (1). In the above formula (1), M is Co, Fe, Cu, Mn, Ni, Cr or a combination thereof. A is a group 13 element, a group 14 element, P, Sb, Bi, Te, or a combination thereof. x, y and z satisfy the following formulas (a) to (d):

[Li_{2-2z}M₂ₓA_{2y}]O (1)

0<x<1 (a)

0<y<1 (b)

x+y≤z<1 (c)

0.2<x/(x+y) (d)

### TECHNICAL FIELD

The present invention relates to a positive active material, a positive electrode, a nonaqueous electrolyte energy storage device, a method of producing a positive active material, a method of producing a positive electrode, and a method of producing a nonaqueous electrolyte energy storage device.

### BACKGROUND ART

Nonaqueous electrolyte secondary batteries typified by lithium ion secondary batteries are widely used for electronic devices such as personal computers and communication terminals, automobiles and the like because these secondary batteries have a high energy density. The nonaqueous electrolyte secondary battery generally has a pair of electrodes, electrically separated from each other with a separator, and a nonaqueous electrolyte interposed between the electrodes, and the secondary battery is configured to allow ions to be transferred between both the electrodes for charge-discharge. Capacitors such as a lithium ion capacitor and an electric double layer capacitor are also widely used as nonaqueous electrolyte energy storage devices other than the nonaqueous electrolyte secondary battery.

Various active materials are used for a positive electrode and a negative electrode of the nonaqueous electrolyte energy storage device, and various composite oxides are widely used as a positive active material. As one of the positive active materials, a transition metal solid solution metal oxide in which a transition metal element such as Co or Fe is made into a solid solution in Li₂O has been developed (see Patent Documents 1 and 2).

### PRIOR ART DOCUMENTS

### Patent Documents

Patent Document 1: JP-A-2015-107890

Patent Document 2: JP-A-2015-32515

### SUMMARY OF THE INVENTION

### Problems to be Solved by the Invention

The positive active material is required to have a large electric capacity and a high average discharge potential. When the electric capacity is large and the average discharge potential is high, a discharge energy density is further increased, so that the energy storage device can be further downsized. However, the above-mentioned conventional positive active material in which a transition metal element is made into a solid solution in Li₂O does not have a sufficiently high average discharge potential.

The present invention has been made in view of the above-described situations, and an object of the present invention is to provide a positive active material having a high average discharge potential, a positive electrode and a nonaqueous electrolyte energy storage device having such a positive active material, a method of producing the positive active material, a method of producing the positive electrode, and a method of producing the nonaqueous electrolyte energy storage device.

### Means for Solving the Problems

One aspect of the present invention made to solve the above problem is a positive active material (I) containing an oxide represented by the following formula (1):

[Li_{2-2z}M_{2z}A_{2y}]O (1)

(In the above formula (1), M is Co, Fe, Cu, Mn, Ni, Cr or a combination thereof. A is a group 13 element, a group 14 element, P, Sb, Bi, Te, or a combination thereof. x, y and z satisfy the following formulas (a) to (d):

0<x<1 (a)

0<y<1 (b)

x+y≤z<1 (c)

0.2<x/(x+y) (d)

Another aspect of the present invention is a positive active material (II) containing an oxide containing lithium, a transition metal element M, and a typical element A, in which the transition metal element M is Co, Fe, Cu, Mn, Ni, Cr or a combination thereof, the typical element A is a group 13 element, a group 14 element, P, Sb, Bi, Te or a combination thereof, a molar ratio (M/(M+A)) of a content of the transition metal element M to a total content of the transition metal element M and the typical element A in the oxide is more than 0.2, and the oxide has a crystal structure belonging to an inverse fluorite structure.

Another aspect of the present invention is a positive electrode for a nonaqueous electrolyte energy storage device having the positive active material (I) or the positive active material (II).

Another aspect of the present invention is a nonaqueous electrolyte energy storage device including the positive electrode.

Another aspect of the present invention is a method of producing a positive active material, including treating a material, containing a transition metal element M and a typical element A, by a mechanochemical method, in which the material contains a lithium transition metal oxide containing the transition metal element M and a compound containing the typical element A, or contains a lithium transition metal oxide containing the transition metal element M and the typical element A, the transition metal element M is Co, Fe, Cu, Mn, Ni, Cr or a combination thereof, the typical element A is a group 13 element, a group 14 element, P, Sb, Bi, Te or a combination thereof, and a molar ratio (M/(M+A)) of a content of the transition metal element M to a total content of the transition metal element M and the typical element A in the material is more than 0.2.

Another aspect of the present invention is a method of producing a nonaqueous electrolyte energy storage device including producing a positive electrode using the positive active material (I) and the positive active material (II).

Another aspect of the present invention is a method of producing a positive electrode for a nonaqueous electrolyte energy storage device, including mechanically milling a mixture containing the positive active material and a conductive agent.

Another aspect of the present invention is a method of producing a nonaqueous electrolyte energy storage device including the positive electrode.

### Advantages of the Invention

The present invention can provide a positive active material having a high average discharge potential, a positive electrode and a nonaqueous electrolyte energy storage device having such a positive active material, a method of producing the positive active material, a method of producing the positive electrode, and a method of producing the nonaqueous electrolyte energy storage device.

### BRIEF DESCRIPTION OF THE DRAWINGS

FIG. 1 is an external perspective view showing an embodiment of a nonaqueous electrolyte energy storage device according to the present invention.

FIG. 2 is a schematic diagram showing an energy storage apparatus including a plurality of the nonaqueous electrolyte energy storage devices according to the present invention.

FIG. 3 is an X-ray diffraction diagram of each oxide obtained in Synthesis Examples 1, 2, and 7 to 9.

FIG. 4 is an X-ray diffraction diagram of each positive active material obtained in Examples 1 to 5 and Comparative Examples 1 and 2.

### MODE FOR CARRYING OUT THE INVENTION

A positive active material according to an embodiment of the present invention is a positive active material (I) containing an oxide (i) represented by the following formula (1):

[Li_{2-2z}M₂ₓA_{2y}]O (1)

(In the above formula (1), M is Co, Fe, Cu, Mn, Ni, Cr or a combination thereof. A is a group 13 element, a group 14 element, P, Sb, Bi, Te, or a combination thereof. x, y and z satisfy the following formulas (a) to (d):

0<x<1 (a)

0<y<1 (b)

x+y≤z<1 (c)

0.2<x/(x+y) (d)

The positive active material (I) has a high average discharge potential. The reason for this is not clear, but the following reason can be surmised. The oxide (i) is typically a composite oxide in which a transition metal element M and a typical element A are made into a solid solution in Li₂O at a predetermined ratio. The typical element A is a p-block element that can be a cation and can be made into a solid solution in Li₂O. Here, a charge-discharge reaction (redox reaction) in the conventional composite oxide in which Co is made into a solid solution in Li₂O is considered to be electron transfer in a Co3d-O2p hybrid orbital. Similarly, when the transition metal element M other than Co is made into a solid solution, it is considered that a redox reaction occurs due to electron transfer in the M3d-O2p hybrid orbital. On the other hand, in the oxide (i) in which the typical element A is made into a solid solution with the transition metal element M in Li₂O at a predetermined ratio, an oxygen atom O is presumed to form an sp hybrid orbital of Asp-O2p in addition to the M3d-O2p hybrid orbital. Since a bond due to the sp hybrid orbital of Asp-O2p is very strong, it is presumed that energy required for electron transfer in the O2p hybrid orbital increases and the discharge potential increases.

In this specification, a composition ratio of the oxide of the positive active material refers to a composition ratio of an oxide which has not been charged or discharged, or an oxide which has been placed in a state of a discharge end by the following method. First, the nonaqueous electrolyte energy storage device is constant-current charged with a current of 0.05 C until the voltage becomes an end-of-charge voltage during normal use, so that a discharge end state is obtained. After a rest of 30 minutes, constant-current discharge is performed with a current of 0.05 C until a potential of the positive electrode reaches 1.5 V (vs. Li/Li⁺), and a completely discharged state state is obtained. As a result of disassembly, if the battery uses a metal lithium electrode as the negative electrode, the additional operation described below is not performed, and a positive electrode is taken out. If the battery uses a negative electrode other than a metal lithium electrode, in order to accurately control the positive electrode potential, as the additional operation, after the battery is disassembled to take out the positive electrode, a test battery using a metal lithium electrode as the counter electrode is assembled. Constant current discharge is performed at a current value of 10 mA per 1 g of the positive composite until the positive potential reaches 2.0 V (vs. Li/Li⁺), and the battery is adjusted to the completely discharged state and then disassembled again to take out the positive electrode. An oxide of the positive active material is collected from the taken-out positive electrode. Here, the term “during normal usage” means use of the nonaqueous electrolyte energy storage device while employing charge-discharge conditions recommended or specified in the nonaqueous electrolyte energy storage device, and when a charger for the nonaqueous electrolyte energy storage device is prepared, this term means use of the nonaqueous electrolyte energy storage device by applying the charger.

The oxide (i) preferably has a crystal structure belonging to the inverse fluorite structure. When the oxide (i) has such a crystal structure, it is presumed that a crystal structure is formed in which the transition metal element M and the typical element A are made into a solid solution in Li₂O having an inverse fluorite structure at a predetermined ratio, and the average discharge potential of the positive active material (I) further increases.

x and z in the above formula (1) preferably satisfy the following formula (e):

0.01≤x/(1−z+x)≤0.2 (e)

The ratio x/(1−z+x) in the above formula (e) is a molar ratio of a content (2x) of the transition metal element M relative to a total content (2−2z+2x) of lithium and the transition metal element M in the oxide (i). When the formula (e) is satisfied, a solid solution amount of the transition metal element M in Li₂O becomes more sufficient, and a discharge capacity can be increased, for example.

A positive active material according to another embodiment of the present invention is a positive active material (II) containing an oxide (ii) containing lithium, a transition metal element M, and a typical element A, in which the transition metal element M is Co, Fe, Cu, Mn, Ni, Cr or a combination thereof, the typical element A is a group 13 element, a group 14 element, P, Sb, Bi, Te or a combination thereof, a molar ratio (M/(M+A)) of a content of the transition metal element M to a total content of the transition metal element M and the typical element A in the oxide (ii) is more than 0.2, and the oxide (ii) has a crystal structure belonging to an inverse fluorite structure.

The positive active material (II) has a high average discharge potential. The reason for this is not clear, but the same reason as for the above-described positive active material (I) is presumed. That is, the oxide (ii) contained in the positive active material (II) is also typically a composite oxide in which the transition metal element M and the typical element A are made into a solid solution in Li₂O at a predetermined ratio, and it is presumed that the same action and effect as those of the above-described oxide (i) occur.

In the positive active material according to an embodiment of the present invention, in an X-ray diffraction diagram of the oxide, a full width at half maximum of a diffraction peak near a diffraction angle 20=33° is preferably 0.3° or more.

Such a configuration can reliably provide a positive active material having a high average discharge potential.

The X-ray diffraction measurement of the oxide is performed by powder X-ray diffraction measurement using an X-ray diffractometer (“MiniFlex II” from Rigaku Corporation) under conditions such that a CuKα ray is used as a radiation source, a tube voltage is 30 kV, and a tube current is 15 mA. At this time, the diffracted X-ray passes through a KB filter having a thickness of 30 μm and is detected by a high-speed one-dimensional detector (D/teX Ultra 2). A sampling width is 0.02°, a scan speed is 5°/min, a divergence slit width is 0.625°, a light receiving slit width is 13 mm (OPEN), and a scattering slit width is 8 mm. The obtained X-ray diffraction pattern is subjected to automatic analysis processing using PDXL (analysis software, manufactured by Rigaku Corporation). Here, “background refinement” and “Auto” are selected in a work window of the PDXL software, and refinement is performed such that an intensity error between an actually measured pattern and a calculated pattern is 1500 or less. Background processing is performed by this refinement, and as a value obtained by subtracting a baseline, a value of peak intensity of each diffraction line, a value of a full width at half maximum, and the like are obtained.

A positive electrode according to an embodiment of the present invention is a positive electrode for a nonaqueous electrolyte energy storage device having the positive active material (I) or the positive active material (II). The positive electrode has the positive active material (I) or the positive active material (II) and thus has a high average discharge potential.

The nonaqueous electrolyte energy storage device according to an embodiment of the present invention is a nonaqueous electrolyte energy storage device (hereinafter also simply referred to as “energy storage device”) including the positive electrode. In the energy storage device, the positive electrode has a high average discharge potential.

A method of producing a positive active material according to an embodiment of the present invention is a method of producing a positive active material, including treating a material, containing a transition metal element M and a typical element A, by a mechanochemical method, in which the material contains a lithium transition metal oxide containing the transition metal element M and a compound containing the typical element A, or contains a lithium transition metal oxide containing the transition metal element M and the typical element A, the transition metal element M is Co, Fe, Cu, Mn, Ni, Cr or a combination thereof, the typical element A is a group 13 element, a group 14 element, P, Sb, Bi, Te or a combination thereof, and a molar ratio (M/(M+A)) of a content of the transition metal element M to a total content of the transition metal element M and the typical element Ain the material is more than 0.2.

According to the production method, a positive active material having a high average discharge potential can be produced.

A method of producing a positive electrode for a nonaqueous electrolyte energy storage device according to an embodiment of the present invention is a method of producing a positive electrode for a nonaqueous electrolyte energy storage device, including using the positive active material (I) or the positive active material (II).

The production method can produce a positive electrode capable of providing an energy storage device in which the positive electrode has a high average discharge potential.

A method of producing a positive electrode for a nonaqueous electrolyte energy storage device according to another embodiment of the present invention is a method of producing a positive electrode for a nonaqueous electrolyte energy storage device, including mechanically milling a mixture containing the positive active material (I) or the positive active material (II) and a conductive agent.

According to the production method, in addition to the above-described effect that a positive active material having a high average discharge potential can be produced, it is possible to produce a positive electrode capable of providing a nonaqueous electrolyte energy storage device having sufficient discharge performance.

The method of producing a nonaqueous electrolyte energy storage device according to an embodiment of the present invention is a method of producing a nonaqueous electrolyte energy storage device including a positive electrode produced by the method of producing a positive electrode for a nonaqueous electrolyte energy storage device.

The production method can produce an energy storage device in which the positive electrode has a high average discharge potential.

Hereinafter, the positive active material, the method of producing a positive active material, the positive electrode, the method of producing a positive electrode, the nonaqueous electrolyte energy storage device, and the method of producing a nonaqueous electrolyte energy storage device according to an embodiment of the present invention will be described in order.

In this specification, the average discharge potential is obtained under the following conditions. A positive electrode having a positive active material is produced. Here, acetylene black is used as a conductive agent, and a mass ratio between the positive active material and acetylene black in the positive electrode is 1:1. A three-electrode cell using the positive electrode as a working electrode and metallic lithium as a counter electrode and a reference electrode is produced. As an electrolyte solution, a nonaqueous electrolyte obtained by dissolving LiPF₆ at a concentration of 1 mol/dm³ in a nonaqueous solvent in which EC, DMC, and EMC are mixed at a volume ratio of 30:35:35 is used. A charge-discharge test is performed in an environment of 25° C. A current density is set to 20 mA/g per mass of the positive active material contained in the positive electrode, and constant current (CC) charge-discharge is performed. The charge-discharge test starts with charging, and the charge is terminated when the electric amount reaches 300 mAh/g which is the upper limit or the potential reaches 4.5 V (vs. Li/Li⁺) which is the upper limit. The discharge is terminated when the electric amount reaches 300 mAh/g which is the upper limit or the potential reaches 1.5 V (vs. Li/Li⁺) which is the lower limit. A discharge energy density (mWh/g) per mass of the positive active material is obtained based on a discharge curve obtained in this test. A value obtained by dividing the discharge energy density by a discharge capacity (mAh/g) per mass of the positive active material is defined as the average discharge potential (vs. Li/Li⁺). That is, the discharge energy density corresponds to an area surrounded by (0,0), (0,y1), (x,y2), and (x,0) when the horizontal axis x is the discharge capacity (mAh/g), the vertical axis y is a positive electrode potential (V vs. Li/Li⁺), a discharge curve is drawn in a first quadrant whose origin is (0,0), and coordinates of the start and end points of the charge-discharge curve are (0,y1) and (x,y2), respectively. The x does not exceed 300 mAh/g, and the y1 and y2 do not exceed 4.5 V (vs. Li/Li⁺).

### <Positive Active Material (I)>

A positive active material (I) according to an embodiment of the present invention contains an oxide (i) represented by the following formula (1):

[Li_{2-2z}M₂ₓA_{2y}]O (1)

In the above formula (1), M is Co, Fe, Cu, Mn, Ni, Cr or a combination thereof. A is a group 13 element, a group 14 element, P, Sb, Bi, Te, or a combination thereof. x, y and z satisfy the following formulas (a) to (d):

0<x<1 (a)

0<y<1 (b)

x+y≤z<1 (c)

0.2<x/(x+y) (d)

The positive active material (I) contains the oxide (i) and thus has a high average discharge potential. The positive active material (I) has a sufficiently large discharge capacity and a sufficiently high discharge energy density.

The transition metal element M preferably contains Co, and Co is more preferable.

Examples of the group 13 element in the typical element A include B, Al, Ga, In and Tl. Examples of the group 14 element include C, Si, Ge, Sn, and Pb. As the typical element A, the group 13 element and the group 14 element are preferable. Furthermore, as the typical element A, a third period element (Al, Si, etc.) and a fourth period element (Ga and Ge) are preferable. Among these, as the typical element A, Al, Si, Ga and Ge are more preferable, Al and Ge are still more preferable, and Al is particularly preferable. By using these typical elements A, the average discharge potential can be further increased.

x in the above formula (1) relates to the content of the transition metal element M made into a solid solution in Li₂O and satisfies the above formula (a). The lower limit of x is preferably 0.01, more preferably 0.03, still more preferably 0.05, and even more preferably 0.06. By setting x to be equal to or more than the above lower limit, the discharge capacity can be increased, for example. In addition, for example, from the viewpoint of further increasing the discharge energy density, the lower limit of x may be even more preferably 0.07. On the other hand, the upper limit of x is preferably 0.5, more preferably 0.2, still more preferably 0.1, may be even more preferably 0.08, and may be particularly preferably 0.07. By setting x to be equal to or less than the above upper limit, the average discharge potential can be further increased.

For these reasons, x in the above formula (1) is preferably 0.01 or more and 0.5 or less, more preferably 0.03 or more and 0.2 or less, still more preferably 0.05 or more and 0.1 or less, and even more preferably 0.06 or more and 0.08 or less.

y in the above formula (1) relates to the content of the typical element A made into a solid solution in Li₂O and satisfies the above formula (b). The lower limit of y is preferably 0.01, more preferably 0.02, still more preferably 0.03, even more preferably 0.04, and particularly preferably 0.05. By setting y to be equal to or more than the above lower limit, the average discharge potential can be further increased. On the other hand, the upper limit of y is preferably 0.5, more preferably 0.2, still more preferably 0.1, and even more preferably 0.07. By setting y to be equal to or less than the above upper limit, the average discharge potential can be further increased. In addition, from the viewpoint of further increasing the discharge energy density, the upper limit of y may be even more preferably 0.05.

For these reasons, y in the above formula (1) is preferably 0.01 or more and 0.5 or less, more preferably 0.02 or more and 0.2 or less, still more preferably 0.03 or more and 0.1 or less, and particularly preferably 0.04 or more and 0.07 or less.

z in the above formula (1) relates to the content of Li and satisfies the above formula (c). When x+y=z holds, there is established a relationship such that a part of the lithium site of Li₂O of the inverse fluorite structure is substituted with the transition metal element M and the typical element A. However, from the relation of the valences of the transition metal element M and the typical element A, the effect is not affected even if x+y<z. The lower limit of z may be 0.02 and is preferably 0.1, more preferably 0.2, and still more preferably 0.25. On the other hand, the upper limit of z may be 1, and is preferably 0.5, more preferably 0.4, and still more preferably 0.35.

Thus, z in the above formula (1) may be 0.02 or more and 1 or less and is preferably 0.1 or more and 0.5 or less, more preferably 0.2 or more and 0.4 or less, and still more preferably 0.25 or more and 0.35 or less.

x/(x+y) in the above formula (d) is a molar ratio of a content (2x) of the transition metal element M relative to a total content (2x+2y) of the transition metal element M and the typical element A in the oxide (i). The lower limit of x/(x+y) is preferably 0.3, more preferably 0.4, and still more preferably 0.5. By setting x/(x+y) to be equal to or more than the above lower limit, the average discharge potential can be further increased. In addition, from the viewpoint of further increasing the discharge energy density, the lower limit of x/(x+y) may be even more preferably 0.6 or may be also even more preferably 0.7. On the other hand, the upper limit of x/(x+y) is less than 1, but is preferably 0.9, more preferably 0.8, still more preferably 0.7, and may be even more preferably 0.6. By setting x/(x+y) to be equal to or less than the above upper limit, the average discharge potential can be further increased.

For these reasons, x/(x+y) in the above formula (d) is preferably 0.3 or more and 0.9 or less, more preferably 0.4 or more and 0.8 or less, and still more preferably 0.5 or more and 0.7 or less. 0.6 may be even more preferable.

x and z in the above formula (1) preferably satisfy the following formula (e):

0.01≤x/(1−z+x)≤0.2 (e)

x/(1−z+x) in the above formula (e) is a molar ratio of the content (2x) of the transition metal element M relative to a total content (2−2z+2x) of lithium and the transition metal element M in the oxide (i). The lower limit of x/(1−z+x) is preferably 0.03, more preferably 0.05, and still more preferably 0.08. By setting x/(1−z+x) to be equal to or more than the above lower limit, the discharge capacity can be increased, for example. In addition, from the viewpoint of further increasing the discharge energy density, the lower limit of x/(1−z+x) may be even more preferably 0.10. On the other hand, the upper limit of x/(1−z+x) is preferably 0.16, more preferably 0.13, and still more preferably 0.10. By setting x/(1−z+x) to be equal to or less than the above upper limit, the average discharge potential can be further increased.

For these reasons, x/(1−z+x) in the above formula (e) is preferably 0.03 or more and 0.16 or less, more preferably 0.05 or more and 0.13 or less, and still more preferably 0.08 or more and 0.10 or less.

x, y, and z in the above formula (1) preferably satisfy the following formula (f):

0.02≤(x+y)/(1−z+x+y)≤0.2 (f)

(x+y)/(1−z+x+y) in the above formula (f) is a molar ratio of the total content (2x+2y) of the content of the transition metal element M and the typical element A relative to a total content (2−2z+2x+2y) of lithium, the transition metal element M, and the typical element A in the oxide (i). The lower limit of (x+y)/(1−z+x+y) is preferably 0.1, more preferably 0.13, still more preferably 0.14, and may be even more preferably 0.15. By setting (x+y)/(1−z+x+y) to be equal to or more than the above lower limit, the average discharge potential can be further increased. On the other hand, the upper limit of (x+y)/(1−z+x+y) is preferably 0.18, and more preferably 0.16. By setting (x+y)/(1−z+x+y) to be equal to or less than the above upper limit, the average discharge potential can be further increased. In addition, from the viewpoint of further increasing the discharge energy density, the upper limit of (x+y)/(1−z+x+y) may be even more preferably 0.15.

For these reasons, (x+y)/(1−z+x+y) in the above formula (f) is preferably 0.1 or more and 0.18 or less, more preferably 0.13 or more and 0.16 or less, and may be still more preferably 0.14 or more and 0.15 or less.

The oxide (i) preferably has a crystal structure belonging to the inverse fluorite structure. The crystal structure of the oxide can be specified by a known analysis method based on an X-ray diffraction diagram (XRD spectrum). A preferable embodiment of the oxide (i) may include a structure in which the transition metal element M and the typical element A are made into a solid solution in the crystal structure of Li₂O having an inverse fluorite structure.

The positive active material (I) may contain components other than the oxide (i). However, the lower limit of the content of the oxide (i) in the positive active material (I) is preferably 70% by mass, more preferably 90% by mass, and still more preferably 99% by mass. The upper limit of the content of this oxide (i) may be 100% by mass. The positive active material (I) may be substantially composed of only the oxide (i). As described above, since most of the positive active material (I) is composed of the oxide (i), the average discharge potential can be further increased.

### <Positive Active Material (II)>

A positive active material (II) according to an embodiment of the present invention contains an oxide (ii) containing lithium, the transition metal element M, and the typical element A. The transition metal element M is Co, Fe, Cu, Mn, Ni, Cr or a combination thereof. The typical element A is a group 13 element, a group 14 element, P, Sb, Bi, Te, or a combination thereof. In the oxide (ii), a molar ratio (M/(M+A)) of the content of the transition metal element M to the total content of the transition metal element M and the typical element A is more than 0.2. The oxide (ii) has a crystal structure belonging to the inverse fluorite structure.

The positive active material (II) contains the oxide (ii) and thus has a high average discharge potential. The positive active material (II) has a sufficiently high discharge energy density.

The oxide (ii) can be preferably represented by the above formula (1). That is, a preferable composition ratio of Li, the transition metal element M, and the typical element A in the oxide (ii), and preferable types of the transition metal element M and the typical element A are the same as those in the oxide (i) described above. The oxide (ii) may further contain elements other than Li, O, the transition metal element M, and the typical element A. However, the lower limit of a total molar ratio of Li, O, the transition metal element M, and the typical element A in the oxide (ii) is preferably 90 mol %, and more preferably 99 mol %.

The positive active material (II) may contain components other than the oxide (ii). However, a preferable content of the oxide (ii) in the positive active material (II) is the same as the content of the oxide (i) in the positive active material (I) described above.

### <Method of Producing Positive Active Material>

The positive active material (I) and the positive active material (II) can be produced, for example, by the following method. That is, a method of producing a positive active material according to an embodiment of the present invention includes treating a material, containing a transition metal element M and a typical element A, by a mechanochemical method,

in which the material (α) contains a lithium transition metal oxide containing the transition metal element M and a compound containing the typical element A, or (β) contains a lithium transition metal oxide containing the transition metal element M and the typical element A,

the transition metal element M is Co, Fe, Cu, Mn, Ni, Cr or a combination thereof,

the typical element A is a group 13 element, a group 14 element, P, Sb, Bi, Te or a combination thereof, and

a molar ratio (M/(M+A)) of a content of the transition metal element M to a total content of the transition metal element M and the typical element A in the material is more than 0.2.

According to the production method, a positive active material containing a composite oxide containing lithium, the transition metal element M, and the typical element A in a predetermined content ratio can be obtained by treating one or a plurality of materials containing a predetermined element by a mechanochemical method.

The mechanochemical method (also referred to as mechanochemical treatment or the like) refers to a synthesis method utilizing a mechanochemical reaction. The mechanochemical reaction refers to a chemical reaction such as a crystallization reaction, a solid solution reaction, or a phase transition reaction that utilizes high energy locally generated by mechanical energy such as friction and compression during a crushing process of a solid substance. In this production method, it is presumed that a reaction for forming a structure in which the transition metal element M and the typical element A are made into a solid solution in the crystal structure of Li₂O is caused by treatment using the mechanochemical method. Examples of apparatuses for performing the mechanochemical method include pulverizers/dispersers such as a ball mill, a bead mill, a vibration mill, a turbo mill, a mechano-fusion, and a disk mill. Among them, the ball mill is preferable. As the ball mill, those made of tungsten carbide (WC) and those made of zirconium oxide (ZrO₂) can be preferably used.

When treatment with the ball mill is performed, the number of revolutions of the balls during the treatment can be set to 100 rpm or more and 1,000 rpm or less, for example. The treatment time can be set to 0.1 hour or more and 10 hours or less, for example. This treatment can be performed in an inert gas atmosphere such as argon or an active gas atmosphere, but is preferably performed in the inert gas atmosphere.

The material subjected to the treatment using the mechanochemical method may be (α) a mixture containing a lithium transition metal oxide containing the transition metal element M and a compound containing the typical element A or (β) a lithium transition metal oxide containing the transition metal element M and the typical element A.

Examples of the lithium transition metal oxide containing the transition metal element M include Li₆CoO₄, Li₅CrO₄, Li₅FeO₄, Li₆NiO₄, Li₆CuO₄, and Li₆MnO₄. These lithium transition metal oxides containing the transition metal element M may have a crystal structure belonging to an inverse fluorite structure or may have another crystal structure. These lithium transition metal oxides can be obtained, for example, by mixing Li₂O, CoO, and the like in a predetermined ratio and firing the mixture in a nitrogen atmosphere.

As the compound containing the typical element A, an oxide containing lithium and the typical element A is preferable. Examples of such compounds include Li₅AlO₄, Li₅GaO₄, Li₅InO₄, Li₄SiO₄, Li₄GeO₄, Li⁴SnO⁴, Li₃BO₃, Li₅SbO₅, Li₅BiO₅, and Li₆TeO₆. The above oxides can be obtained, for example, by mixing Li₂O, Al₂O₃, and the like in a predetermined ratio and firing the mixture in a nitrogen atmosphere. The compound containing the typical element A may have a crystal structure belonging to an inverse fluorite structure or may have another crystal structure.

When a mixture containing a lithium transition metal oxide containing the transition metal element M and a compound containing the typical element A is used as a material, the type and mixing ratio of the materials used are adjusted so that the molar ratio (M/(M+A)) of the content of the transition metal element M to the total content of the transition metal element M and the typical element A contained in the mixture is more than 0.2.

Examples of the lithium transition metal oxide containing the transition metal element M and the typical element A include a lithium transition metal oxide represented by LiₐM_{b}A_{c}O₄ (0<a≤6, 0<b<1, 0<c<1, 0.2<b/(b+c)) such as Li₅₅Co_{0.5}Al_{0.5}O₄ and Li_{5.8}Co_{0.8}Al_{0.2}O₄. The lithium transition metal oxide containing the transition metal element M and the typical element A can be obtained by a known method such as a firing method. The crystal structure of these lithium transition metal oxides is not particularly limited, for example, may be a crystal structure of each oxide used as the material, such as a crystal structure (crystal structure such as Li₆CoO₄) that can be assigned to the space group P42/nmc and a crystal structure (crystal structure such as Li₅AlO₄) that can be assigned to the space group Pmmn-2, and may include a plurality of crystal structures. It should be noted that “−2” in the notation of the space group described above represents a target element of a two-fold rotation—inversion axis, and should be originally indicated by “2” with an upper bar “-”. The lithium transition metal oxide containing the transition metal element M and the typical element A may be an oxide in which a plurality of phases coexist. Examples of such an oxide include an oxide in which Al solid solution Li₆CoO₄ and Co solid solution Li₅AlO₄ coexist. It is presumed that a reaction for forming a structure in which Co as the transition metal element and Al as the typical element are made into a solid solution in the crystal structure of Li₂O is caused by subjecting such an oxide to the treatment using the mechanochemical method.

### <Positive Electrode>

A positive electrode according to an embodiment of the present invention is a positive electrode for a nonaqueous electrolyte energy storage device having the positive active material (I) or the positive active material (II) described above. The positive electrode has a positive substrate and a positive active material layer disposed directly or via an intermediate layer on the positive substrate.

The positive substrate has conductivity. As the material of the substrate, a metal such as aluminum, titanium, tantalum, or stainless steel, or an alloy thereof is used. Among these materials, aluminum and an aluminum alloy are preferable for the balance among the potential resistance, conductivity level, and cost. Exemplified as a form of the positive substrate are a foil and a deposited film, and a foil is preferable in terms of costs. That is, an aluminum foil is preferable as the positive substrate. Examples of aluminum and the aluminum alloy include A1085P and A3003P specified in JIS-H-4000 (2014).

The intermediate layer is a covering layer on the surface of the positive substrate, and reduces contact resistance between the positive substrate and the positive active material layer by including conductive particles such as carbon particles. The configuration of the intermediate layer is not particularly limited, and can be formed from, for example, a composition containing a resin binder and conductive particles. Having “conductivity” means having a volume resistivity of 10⁷ Ω·cm or less that is measured in accordance with JIS-H-0505 (1975), and the term “non-conductivity” means that the volume resistivity is more than 10⁷ Ω·cm.

The positive active material layer is formed from a so-called positive composite containing a positive active material. The positive composite that forms the positive active material layer contains optional components such as a conductive agent, a binder (binding agent), a thickener and a filler as necessary.

The positive active material includes the positive active material (I) or the positive active material (II) described above. As the positive active material, a well-known positive active material other than the positive active material (I) and the positive active material (II) may be included. The content ratio of the positive active material (I) and the positive active material (II) in the total positive active material is preferably 50% by mass or more, more preferably 70% by mass or more, still more preferably 90% by mass or more, and even more preferably 99% by mass or more. The average discharge potential can be sufficiently increased by increasing the content ratios of the positive active material (I) and the positive active material (II). The content ratio of the positive active material in the positive active material layer can be, for example, 30% by mass or more and 95% by mass or less.

The conductive agent is not particularly limited as long as it is a conductive material. Examples of such a conductive agent include: a carbonaceous material; a metal; and a conductive ceramic. Examples of the carbonaceous material include graphite and carbon black. Examples of the kind of carbon black include furnace black, acetylene black, and Ketjen black. Among them, a carbonaceous material is preferable from the viewpoint of conductivity and coatability. Among them, acetylene black and Ketjen black are preferable. Examples of the shape of the conductive agent include a powdery shape, a sheet shape, and a fibrous shape.

Examples of the binder (binding agent) include thermoplastic resins such as fluororesins (polytetrafluoroethylene (PTFE), polyvinylidene fluoride (PVDF) and the like), polyethylene, polypropylene and polyimide; elastomers such as ethylene-propylene-diene rubber (EPDM), sulfonated EPDM, styrene butadiene rubber (SBR) and fluorine rubber; and polysaccharide polymers.

Examples of the thickener include polysaccharide polymers such as carboxymethylcellulose (CMC) and methylcellulose. When the thickener has a functional group reactive with lithium, it is preferable to deactivate the functional group by methylation or the like in advance.

The filler is not particularly limited as long as it is a filler that does not adversely affect the energy storage device performance. Examples of the main component of the filler include polyolefins such as polypropylene and polyethylene, silica, alumina, zeolite and glass.

### <Nonaqueous Electrolyte Energy Storage Device>

The energy storage device according to an embodiment of the present invention has a positive electrode, a negative electrode, and a nonaqueous electrolyte. Hereinafter, a nonaqueous electrolyte secondary battery (hereinafter also simply referred to as “secondary battery”) will be described as an example of an energy storage device. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case, a resin case or the like, which is usually used as a case of a secondary battery, can be used.

### (Positive Electrode)

The positive electrode included in the secondary battery is as described above.

Here, when the positive active material and a conductive agent are mixed, it is preferable to mechanically mill a mixture containing the positive active material and the conductive agent. As shown in Examples described later, when a positive active material containing the typical element A is used, the mechanical milling treatment is performed in a state of containing a conductive agent, so that it is possible to reliably produce a positive electrode capable of providing a nonaqueous electrolyte energy storage device having sufficient discharge performance.

Here, the mechanical milling treatment refers to a treatment of applying mechanical energy such as impact, shear stress, or friction to perform pulverization, mixing, or compounding. Examples of apparatuses for performing the mechanical milling treatment include pulverizers/dispersers such as a ball mill, a bead mill, a vibration mill, a turbo mill, a mechano-fusion, and a disk mill. Among them, the ball mill is preferable. As the ball mill, those made of tungsten carbide (WC) and those made of zirconium oxide (ZrO₂) can be preferably used. The mechanical milling treatment here does not need to involve the mechanochemical reaction.

When treatment with the ball mill is performed, the number of revolutions of the balls during the treatment can be set to 100 rpm or more and 1,000 rpm or less, for example. The treatment time can be set to 0.1 hour or more and 10 hours or less, for example. This treatment can be performed in an inert gas atmosphere such as argon or an active gas atmosphere, but is preferably performed in the inert gas atmosphere.

### (Negative Electrode)

The negative electrode has a negative substrate and a negative active material layer disposed directly or via an intermediate layer on the negative substrate. The intermediate layer may have the same configuration as the intermediate layer of the positive electrode.

The negative substrate may have the same configuration as the positive substrate. However, as the material of the negative substrate, metals such as copper, nickel, stainless steel, and nickel-plated steel or alloys thereof are used, and copper or a copper alloy is preferable. That is, a copper foil is preferable as the negative substrate. Examples of the copper foil include rolled copper foils and electrolytic copper foils.

The negative active material layer is formed from a so-called negative composite containing a negative active material. The negative composite that forms the negative active material layer contains optional components such as a conductive agent, a binder (binding agent), a thickener and a filler as necessary. As regards the optional component such as a conducting agent, a binder (binding agent), a thickener, or a filler, it is possible to use the same component as in the positive active material layer.

As the negative active material, a material capable of absorbing and releasing lithium ions is normally used. Specific examples of the negative active material include: metals or metalloids such as Si and Sn; metal oxides or metalloid oxides such as an Si oxide and an Sn oxide; a polyphosphoric acid compound; and carbon materials such as graphite and non-graphitic carbon (easily graphitizable carbon or hardly graphitizable carbon).

The negative composite (negative active material layer) may also contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Ta, Hf, Nb, or W.

### (Separator)

As a material of the separator, for example, a woven fabric, a nonwoven fabric, a porous resin film or the like is used. Among them, a porous resin film is preferable from the viewpoint of strength, and a nonwoven fabric is preferable from the viewpoint of liquid retainability of the nonaqueous electrolyte. As a main component of the separator, a polyolefin such as polyethylene or polypropylene is preferable from the viewpoint of strength, and polyimide, aramid or the like is preferable from the viewpoint of resistance to oxidation and decomposition. These resins may be combined.

An inorganic layer may be disposed between the separator and the electrode (normally the positive electrode). The inorganic layer is a porous layer that is also called a heat-resistant layer or the like. It is also possible to use a separator with an inorganic layer formed on one surface of a porous resin film. The inorganic layer normally includes inorganic particles and a binder, and may contain other components.

### (Nonaqueous Electrolyte)

As the nonaqueous electrolyte, a known nonaqueous electrolyte that is normally used in a common nonaqueous electrolyte secondary battery can be used. The nonaqueous electrolyte contains a nonaqueous solvent, and an electrolyte salt dissolved in the nonaqueous solvent.

As the nonaqueous solvent, a known nonaqueous solvent that is normally used as a nonaqueous solvent of a common nonaqueous electrolyte for a secondary battery can be used. Examples of the nonaqueous solvent include cyclic carbonate, linear carbonate, esters, ethers, amides, sulfone, lactones and nitriles. Among these nonaqueous solvents, it is preferable to use at least cyclic carbonate or chain carbonate, and it is more preferable to use cyclic carbonate and chain carbonate in combination.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, catechol carbonate, 1-phenylvinylene carbonate and 1,2-diphenylvinylene carbonate, and among them, EC is preferable.

Examples of the chain carbonate include diethyl carbonate (DEC), dimethyl carbonate (DMC), ethyl methyl carbonate (EMC) and diphenyl carbonate, and among them, DMC and EMC are preferable.

Examples of the electrolyte salt include lithium salts, sodium salts, potassium salts, magnesium salts and onium salts, with lithium salts being preferable. Examples of the lithium salt include inorganic lithium salts such as LiPF₆, LiPO₂F₂, LiBF₄, LiPF₂(C₂O₄)₂, LiClO₄, and LiN(SO₂F)₂, and lithium salts having a fluorinated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃.

Other additives may be added to the nonaqueous electrolyte. As the nonaqueous electrolyte described above, a salt that is melted at normal temperature, an ionic liquid, a polymer solid electrolyte, or the like can also be used.

### <Method of Producing Nonaqueous Electrolyte Energy Storage Device>

The energy storage device can be produced by using the above positive active material (I) or the above positive active material (II). For example, the method of producing the energy storage device includes a step of preparing a positive electrode, a step of preparing a negative electrode, a step of preparing a nonaqueous electrolyte, a step of forming an electrode assembly in which the positive electrode and the negative electrode are alternately superposed by stacking or winding the positive electrode and the negative electrode with a separator interposed between the electrodes, a step of housing the positive electrode and the negative electrode (electrode assembly) in a case, and a step of injecting the nonaqueous electrolyte into the case. The energy storage device can be obtained by sealing an injection port after the injection.

In the step of preparing a positive electrode, the positive active material (I) or the positive active material (II) is used. The positive electrode can be produced by, for example, applying a positive composite paste directly or via an intermediate layer to the positive substrate and drying the paste. The positive composite paste contains each component constituting the positive composite, such as a positive active material.

### OTHER EMBODIMENTS

The present invention is not limited to the aforementioned embodiments, and, in addition to the aforementioned embodiments, can be carried out in various modes with alterations and/or improvements being made. For example, in the positive electrode of the nonaqueous electrolyte energy storage device, the positive composite is not required to form a distinct layer. For example, the positive electrode may have a structure in which a positive composite is carried on a mesh-shaped positive substrate.

In the above-described embodiment, an embodiment in which the nonaqueous electrolyte energy storage device is a nonaqueous electrolyte secondary battery has been mainly described, but the nonaqueous electrolyte energy storage device may be one other than a nonaqueous electrolyte secondary battery. Examples of another nonaqueous electrolyte energy storage device include capacitors (electric double layer capacitors and lithium ion capacitors).

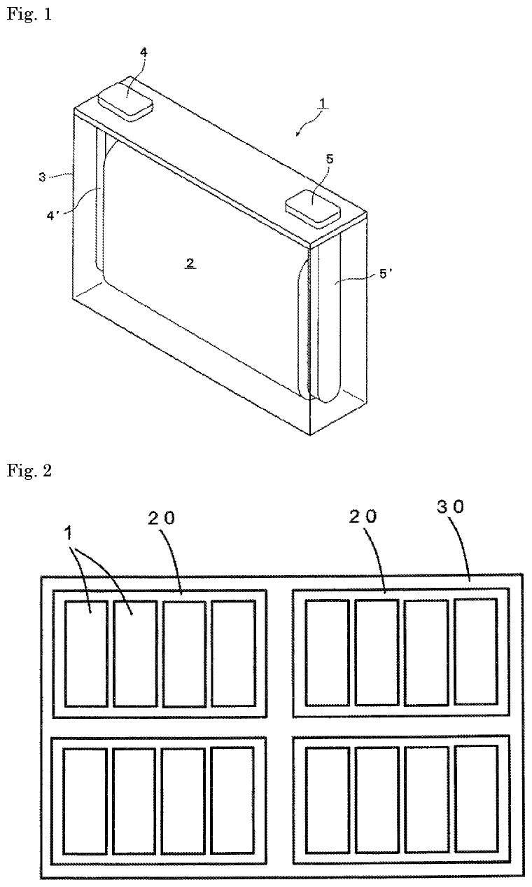

FIG. 1 is a schematic view of a rectangular nonaqueous electrolyte energy storage device 1 (nonaqueous electrolyte secondary battery) as an embodiment of the nonaqueous electrolyte energy storage device according to the present invention. FIG. 1 is a view showing an inside of a case in a perspective manner. In the nonaqueous electrolyte energy storage device 1 shown in FIG. 1, an electrode assembly 2 is housed in a battery case 3. The electrode assembly 2 is formed by winding a positive electrode, including a positive composite containing positive active material, and a negative electrode, including a negative active material, with a separator interposed between the electrodes. The positive electrode is electrically connected to a positive electrode terminal 4 through a positive electrode lead 4′, and the negative electrode is electrically connected to a negative electrode terminal 5 through a negative electrode lead 5′. The positive active material (I) or the positive active material (II) according to an embodiment of the present invention is used as the active material of the positive electrode. A nonaqueous electrolyte is injected in the battery case 3.

The configuration of the nonaqueous electrolyte energy storage device according to the present invention is not particularly limited, and examples include cylindrical batteries, prismatic batteries (rectangular batteries) and flat batteries. The present invention can also be implemented as an energy storage apparatus including a plurality of the nonaqueous electrolyte energy storage devices as described above. FIG. 2 shows an embodiment of an energy storage apparatus. In FIG. 2, an energy storage apparatus 30 includes a plurality of energy storage units 20. Each of the energy storage units 20 includes a plurality of the nonaqueous electrolyte energy storage devices 1. The energy storage apparatus 30 can be mounted as a power source for an automobile such as an electric vehicle (EV), a hybrid vehicle (HEV), a plug-in hybrid vehicle (PHEV), or the like.

### EXAMPLES

Hereinafter, the present invention will be described further in detail by way of examples, but the present invention is not limited to the following examples.

### [Synthesis Example 1] Synthesis of Li₆CoO₄

After Li₂O and CoO were mixed at a molar ratio of 3:1, the mixture was fired at 900° C. for 20 hours under a nitrogen atmosphere to synthesize Li₆CoO₄.

### [Synthesis Example 2] Synthesis of Li₅AlO₄

After Li₂O and Al₂O₃ were mixed at a molar ratio of 5:1, the mixture was fired at 900° C. for 20 hours under an air atmosphere to obtain Li₅AlO₄.

### [Synthesis Example 3] Synthesis of Li₅GaO₄

After Li₂O and Ga₂O₃ were mixed at a molar ratio of 5:1, the mixture was fired at 900° C. for 20 hours under a nitrogen atmosphere to synthesize Li₅GaO₄.

### [Synthesis Example 4] Synthesis of Li₄SiO₄

After Li₂O and SiO₂ were mixed at a molar ratio of 2:1, the mixture was fired at 900° C. for 12 hours under an air atmosphere to obtain Li₄SiO₄.

### [Synthesis Example 5] Synthesis of Li₄GeO₄

After Li₂O and GeO₂ were mixed at a molar ratio of 2:1, the mixture was fired at 900° C. for 20 hours under a nitrogen atmosphere to synthesize Li₄GeO₄.

### [Synthesis Example 6] Synthesis of Li₆ZnO₄

After Li₂O and ZnO were mixed at a molar ratio of 3:1, the mixture was fired at 900° C. for 20 hours under a nitrogen atmosphere to synthesize Li₆ZnO₄.

### [Synthesis Example 7] Synthesis of Li_{5.8}Co_{0.8}Al_{0.2}O₄

After Li₂O, CoO, and Al₂O₃ were mixed at a molar ratio of 29:8:1, the mixture was fired at 900° C. for 20 hours under a nitrogen atmosphere to synthesize Li_{5.8}Co_{0.8}Al_{0.2}O₄.

### [Synthesis Example 8] Synthesis of Li_{5.5}Co_{0.5}Al_{0.5}O₄

After Li₂O, CoO, and Al₂O₃ were mixed at a molar ratio of 11:2:1, the mixture was fired at 900° C. for 20 hours under a nitrogen atmosphere to synthesize Li_{5.5}Co_{0.5}Al_{0.5}O₄.

### [Synthesis Example 9] Synthesis of Li_{5.2}Co_{0.2}Al_{0.8}O₄

After Li₂O, CoO, and Al₂O₃ were mixed at a molar ratio of 13:1:2, the mixture was fired at 900° C. for 20 hours under a nitrogen atmosphere to synthesize Li_{5.2}Co_{0.2}Al_{0.8}O₄.

### (X-Ray Diffraction Measurement of Lithium Cobalt Oxide, Lithium Aluminum Oxide, and Lithium Cobalt Aluminum Oxide)

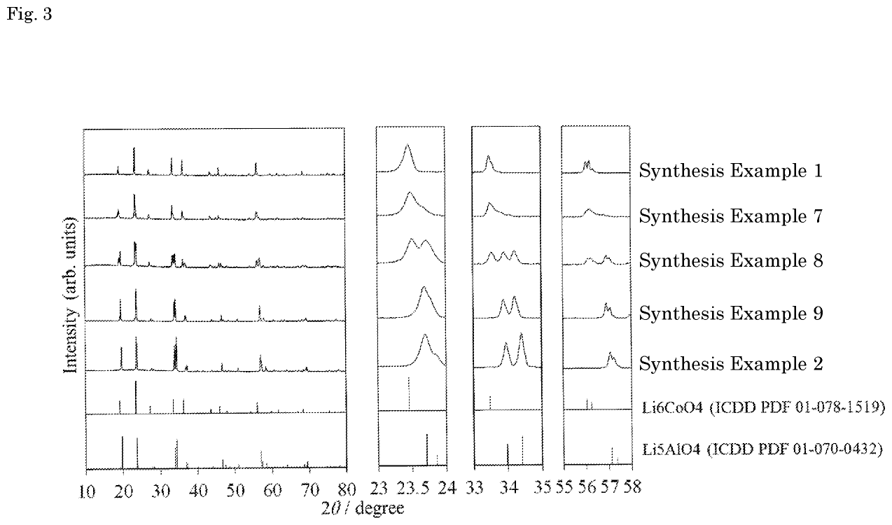

X-ray diffraction measurement was performed on Li₆CoO₄ (Synthesis Example 1), Li₅AlO₄ (Synthesis Example 2), Li_{5.8}Co_{0.8}Al_{0.2}O₄ (Synthesis Example 7), Li_{5.5}Co_{0.5}Al_{0.5}O₄ (Synthesis Example 8), and Li_{5.2}Co_{0.2}Al_{0.8}O₄ (Synthesis example 9) obtained in the above Synthesis Examples. A powder sample was filled under an argon atmosphere using an airtight sample holder for X-ray diffraction measurement. An X-ray diffractometer used, measurement conditions, and a data processing method were as described above. FIG. 3 shows each X-ray diffraction diagram (XRD spectrum).

From the XRD spectrum of Synthesis Example 1 (Li₆CoO₄), a single phase that can be assigned to the space group P42/nmc can be confirmed, and it can be confirmed that the target Li₆CoO₄ has been synthesized.

From the XRD spectrum of Synthesis Example 2 (Li₅AlO₄), a single phase that can be assigned to the space group Pmmn-2 can be confirmed, and it can be confirmed that the target Li₅AlO₄ has been synthesized.

From the XRD spectrum of Synthesis Example 7 (Li_{5.8}Co_{0.8}Al_{0.2}O₄), Li₆CoO₄ can be confirmed as a main phase, a phase of Li₅AlO₄ is slightly detected, and it can be seen that peak shift occurs in both cases. It is presumed that Al solid solution Li₆CoO₄ and Co solid solution Li₅AlO₄ coexist.

From the XRD spectrum of Synthesis Example 8 (Li_{5.5}Co_{0.5}Al_{0.5}O₄), both phases of Li₆CoO₄ and Li₅AlO₄ can be confirmed, and it can be seen that the peak shift occurs in both cases. It is presumed that Al solid solution Li₆CoO₄ and Co solid solution Li₅AlO₄ coexist.

From the XRD spectrum of Synthesis Example 9 (Li_{5.2}Co_{0.2}Al_{0.8}O₄), only Li₅AlO₄ can be confirmed, and it can be seen that the peak shift occurs. It is presumed that Co has been substituted in Li₅AlO₄ to form a solid solution.

### Example 1

The obtained Li₆CoO₄ and Li₅AlO₄ were mixed at a molar ratio of 5:4, and then treated in a tungsten carbide (WC) ball mill under an argon atmosphere at a revolution speed of 400 rpm for 2 hours. A positive active material (Li_{1.389}Co_{0.139}Al_{0.111}O) of Example 1 was obtained by treatment using the mechanochemical method as described above.

### Examples 2 to 6 and Comparative Examples 1 to 5

Each positive active material of Examples 2 to 6 and Comparative Examples 1 to 5 was obtained in the same manner as in Example 1, except that the materials used, the type of ball mill, the number of revolutions, and the treatment time were as shown in Table 1. In Table 1, ZrO₂ represents a zirconium oxide ball mill. Table 1 also shows a composition formula of the obtained positive active material (oxide).

TABLE 1

| | | | Number of | Treatment | | | |
|---|---|---|---|---|---|---|---|
| | | Ball | revolutions | time | | | |
| | Material | mill | (rpm) | (h) | [Li_{2-2z}M_{2X}A_{2y}]O | M | A |
| Example 1 | 5Li₆CoO₄ + 4Li₅AlO₄ | WC | 400 | 2 | Li_{1.389}Co_{0.139}Al_{0.111}O | Co | Al |
| Example 2 | Li_{5.5}Co_{0.5}Al_{0.5}O₄ | ZrO₂ | 600 | 0.5 | Li_{1.375}Co_{0.125}Al_{0.125}O | Co | Al |
| Example 3 | 5Li₆CoO₄ + 5Li₅GaO₄ | WC | 300 | 3 | Li_{1.375}Co_{0.125}Ga_{0.125}O | Co | Ga |
| Example 4 | 5Li₆CoO₄ + 5Li₄SiO₄ | WC | 300 | 3 | Li_{1.25}Co_{0.125}Si_{0.125}O | Co | Si |
| Example 5 | 5Li₆CoO₄ + 5Li₄GeO₄ | WC | 300 | 3 | Li_{1.25}Co_{0.125}Ge_{0.125}O | Co | Ge |
| Example 6 | Li_{5.8}Co_{0.8}Al_{0.2}O₄ | ZrO₂ | 600 | 0.5 | Li_{1.45}Co_{0.2}Al_{0.05}O | Co | Al |
| Comparative | Li₆CoO₄ | WC | 400 | 8 | Li_{1.5}Co_{0.25}O | Co | — |
| Example 1 | | | | | | | |
| Comparative | 5Li₆CoO₄ + 5Li₆ZnO₄ | WC | 300 | 3 | Li_{1.5}Co_{0.125}Zn_{0.125}O | Co | Zn |
| Example 2 | | | | | | | |
| Comparative | Li₆CoO₄ | ZrO₂ | 600 | 0.5 | Li_{1.5}Co_{0.25}O | Co | — |
| Example 3 | | | | | | | |
| Comparative | Li_{5.2}Co_{0.2}Al_{0.8}O₄ | ZrO₂ | 600 | 0.5 | Li_{1.3}Co_{0.05}Al_{0.2}O | Co | Al |
| Example 4 | | | | | | | |
| Comparative | Li₅AlO₄ | ZrO₂ | 600 | 0.5 | Li_{1.25}Al_{0.25}O | — | Al |
| Example 5 | | | | | | | |

| | | | | | | (x + y)/ |
|---|---|---|---|---|---|---|
| | | | | x/ | x/ | (1 − |
| | x | y | z | (x + y) | (1 − z + x) | z + x + y) |
| Example 1 | 0.0694 | 0.0555 | 0.3056 | 0.556 | 0.091 | 0.153 |
| Example 2 | 0.0625 | 0.0625 | 0.3125 | 0.5 | 0.083 | 0.154 |
| Example 3 | 0.0625 | 0.0625 | 0.3125 | 0.5 | 0.083 | 0.154 |
| Example 4 | 0.0625 | 0.0625 | 0.375 | 0.5 | 0.091 | 0.167 |
| Example 5 | 0.0625 | 0.0625 | 0.375 | 0.5 | 0.091 | 0.167 |
| Example 6 | 0.1 | 0.025 | 0.275 | 0.8 | 0.121 | 0.147 |
| Comparative | 0.125 | 0 | 0.25 | 1 | 0.143 | 0.143 |
| Example 1 | | | | | | |
| Comparative | 0.0625 | 0.0625 | 0.25 | 0.5 | 0.077 | 0.143 |
| Example 2 | | | | | | |
| Comparative | 0.125 | 0 | 0.25 | 1 | 0.143 | 0.143 |
| Example 3 | | | | | | |
| Comparative | 0.025 | 0.1 | 0.35 | 0.2 | 0.037 | 0.161 |
| Example 4 | | | | | | |
| Comparative | 0 | 0.125 | 0.375 | 0 | 0 | 0.200 |
| Example 5 | | | | | | |

### (X-Ray Diffraction Measurement of Positive Active Material)

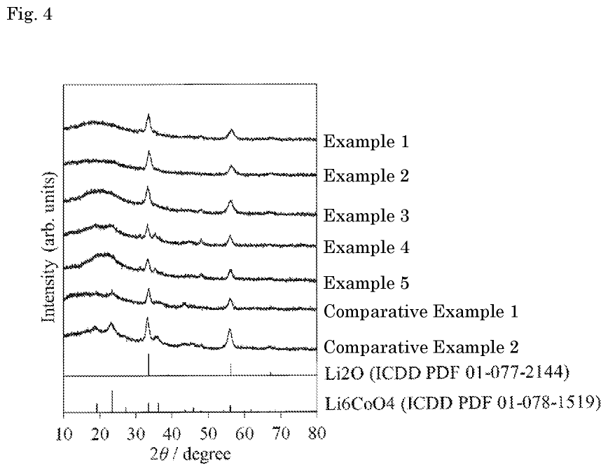

The X-ray diffraction measurement was performed on each positive active material, obtained in the above Examples and Comparative Examples, by the same method as described above. It could be confirmed that each positive active material had as a main phase a crystal structure (inverse fluorite structure) similar to Li₂O. FIG. 4 shows an X-ray diffraction diagram (XRD spectrum) of each positive active material of Examples 1 to 5 and Comparative Examples 1 and 2.

### (Features on X-Ray Diffraction Diagram)

As can be seen from FIG. 4, in the X-ray diffraction diagram of the positive active materials according to Examples, a characteristic diffraction peak is observed near a diffraction angle 2θ=33°. As can be seen by comparing with FIG. 3, a full width at half maximum of the diffraction peak near 33° remarkably increases through the mechanochemical treatment. Specifically, in the material before the mechanochemical treatment, the full width at half maximum of the diffraction peak near 33° was less than 0.3° in each case. For example, the full width at half maximum was 0.10° in Synthesis Example 1, was 0.16° in Synthesis Example 2, and was 0.15° in Synthesis Example 8. On the other hand, in the positive active material obtained through the mechanochemical treatment, the full width at half maximum of the diffraction peak near 33° was 0.3° or more in each case. For example, the full width at half maximum was 1.10° in Example 1 and was 0.83° in Comparative Example 1.

### (Production of Positive Electrode)

The positive active material obtained in each of Examples and Comparative Examples and acetylene black were mixed at a mass ratio of 1:1 and placed in a WC pot having an inner volume of 80 mL and containing 250 g of WC balls having a diameter of 5 mm, and the pot was closed with a lid. The pot was set in a planetary ball mill (“pulverisette 5” from FRITSCH) and dry-pulverized at a revolution speed of 200 rpm for 2 hours to prepare a mixed powder of the positive active material and acetylene black.

A solution obtained by dissolving a PVDF powder in an N-methyl-2-pyrrolidone (NMP) solvent was added to the obtained mixed powder of the positive active material and acetylene black to prepare a positive composite paste. A mass ratio of the positive active material, acetylene black, and PVDF in the positive composite paste was 2:2:1 (in terms of solid content). The positive composite paste was applied to a mesh-shaped aluminum substrate, dried, and then pressed to obtain a positive electrode.

### (Production of Nonaqueous Electrolyte Energy Storage Device (Evaluation Cell))

LiPF₆ was dissolved at a concentration of 1 mol/dm³ in a nonaqueous solvent in which EC, DMC, and EMC were mixed at a volume ratio of 30:35:35 to prepare a nonaqueous electrolyte. Using the positive electrode and the nonaqueous electrolyte, and using the negative electrode and a reference electrode as lithium metal, a three-electrode beaker cell as an evaluation cell (energy storage device) was produced. All operations from the production of the positive electrode to the production of the evaluation cell were performed in an argon atmosphere.

### (Charge-Discharge Test)

With respect to the evaluation cells obtained using the respective positive active materials of Examples 1 to 6 and Comparative Examples 1 to 5, a charge-discharge test was performed in a 25° C. temperature environment in a glove box under an argon atmosphere. A current density was set to 20 mA/g per mass of the positive active material contained in the positive electrode, and constant current (CC) charge-discharge was performed. The charge-discharge test started with charging, and the charge was terminated when the electric amount reached 300 mAh/g which was the upper limit or the potential reached 4.5 V (vs. Li/Li⁺) which was the upper limit. The discharge was terminated when the electric amount reached 300 mAh/g which was the upper limit or the potential reached 1.5 V (vs. Li/Li⁺) which was the lower limit. Tables 2 and 3 show the amount of charge, the discharge capacity, the average discharge potential, and the discharge energy density in the charge-discharge test. The results of Examples 1 and 2 are shown in both Table 2 and Table 3.

For each of the positive active materials of Examples 2 and 6 and Comparative Examples 3 to 5, the same evaluation cell as above was separately prepared, and a test was performed in which the upper limit of the charge/discharge electricity amount was changed to 350 mAh/g in a 25° C. temperature environment. That is, the charge-discharge test was performed in the same manner as above except that the charge was terminated when the electric amount reached 350 mAh/g which was the upper limit or the potential reached 4.5 V (vs. Li/Li⁺) which was the upper limit, and the discharge was terminated when the electric amount reached 350 mAh/g which was the upper limit or the potential reached 1.5 V (vs. Li/Li⁺) which was the lower limit. The evaluation results are shown in Table 4. Although Table 4 also has a column for the average discharge potential, since the test conditions are different from the test results shown in Tables 2 and 3, the values in this column are reference values.

TABLE 2

| | | | | | | | | x/ |
|---|---|---|---|---|---|---|---|---|
| | [Li_{2-2z}M₂ₓA_{2y}]O | M | A | x | y | z | x/(x + y) | (1 − z + x) |
| Example 1 | Li_{1.389}Co_{0.139}Al_{0.111}O | Co | Al | 0.0694 | 0.0555 | 0.3056 | 0.556 | 0.091 |
| Example 2 | Li_{1.375}Co_{0.125}Al_{0.125}O | Co | Al | 0.0625 | 0.0625 | 0.3125 | 0.5 | 0.083 |
| Example 3 | Li_{1.375}Co_{0.125}Ga_{0.125}O | Co | Ga | 0.0625 | 0.0625 | 0.3125 | 0.5 | 0.083 |
| Example 4 | Li_{1.25}Co_{0.125}Si_{0.125}O | Co | Si | 0.0625 | 0.0625 | 0.375 | 0.5 | 0.091 |
| Example 5 | Li_{1.25}Co_{0.125}Ge_{0.125}O | Co | Ge | 0.0625 | 0.0625 | 0.375 | 0.5 | 0.091 |
| Comparative | Li_{1.5}Co_{0.25}O | Co | — | 0.125 | 0 | 0.25 | 1 | 0.143 |
| Example 1 | | | | | | | | |
| Comparative | Li_{1.5}Co_{0.125}Zn_{0.125}O | Co | Zn | 0.0625 | 0.0625 | 0.25 | 0.5 | 0.077 |
| Example 2 | | | | | | | | |

| | | | | Average | |
|---|---|---|---|---|---|
| | (x + y)/ | Amount of | Discharge | discharge | Discharge |
| | (1 − | charge | capacity | potential | energy density |
| | z + x + y) | mAh/g | mAh/g | V (vs. Li/Li⁺) | mWh/g |
| Example 1 | 0.153 | 300 | 300 | 2.610 | 783 |
| Example 2 | 0.154 | 300 | 300 | 2.601 | 780 |
| Example 3 | 0.154 | 300 | 300 | 2.581 | 774 |
| Example 4 | 0.167 | 300 | 300 | 2.593 | 777 |
| Example 5 | 0.167 | 300 | 300 | 2.608 | 782 |
| Comparative | 0.143 | 300 | 300 | 2.420 | 726 |
| Example 1 | | | | | |
| Comparative | 0.143 | 300 | 295 | 2.426 | 715 |
| Example 2 | | | | | |

TABLE 3

| | [Li_{2-2z}M₂ₓA_{2y}]O | M | A | x | y | z | x/(x + y) |
|---|---|---|---|---|---|---|---|
| Comparative | Li_{1.5}Co_{0.25}O | Co | — | 0.125 | 0 | 0.25 | 1 |
| Example 3 | | | | | | | |
| Example 6 | Li_{1.45}Co_{0.2}Al_{0.05}O | Co | Al | 0.1 | 0.025 | 0.275 | 0.8 |
| Example 1 | Li_{1.389}Co_{0.139}Al_{0.111}O | Co | Al | 0.0694 | 0.0555 | 0.3056 | 0.556 |
| Example 2 | Li_{1.375}Co_{0.125}Al_{0.125}O | Co | Al | 0.0625 | 0.0625 | 0.3125 | 0.5 |
| Comparative | Li_{1.3}Co_{0.05}Al_{0.2}O | Co | Al | 0.025 | 0.1 | 0.35 | 0.2 |
| Example 4 | | | | | | | |
| Comparative | Li_{1.25}Al_{0.25}O | — | Al | 0 | 0.125 | 0.375 | 0 |
| Example 5 | | | | | | | |

| | | | | | Average | |
|---|---|---|---|---|---|---|
| | (x + y)/ | | Amount of | Discharge | discharge | Discharge |
| | (1 − | x/ | charge | capacity | potential | energy density |
| | z + x + y) | (1 − z + x) | mAh/g | mAh/g | V (vs. Li/Li⁺) | mWh/g |
| Comparative | 0.143 | 0.143 | 300 | 300 | 2.464 | 739 |
| Example 3 | | | | | | |
| Example 6 | 0.147 | 0.121 | 300 | 300 | 2.534 | 760 |
| Example 1 | 0.153 | 0.091 | 300 | 300 | 2.610 | 783 |
| Example 2 | 0.154 | 0.083 | 300 | 300 | 2.601 | 780 |
| Comparative | 0.161 | 0.037 | 291 | 79 | 2.310 | 182 |
| Example 4 | | | | | | |
| Comparative | 0.200 | 0 | 77 | 64 | 2.387 | 153 |
| Example 5 | | | | | | |

TABLE 4

| | | | | | | | | x/ |
|---|---|---|---|---|---|---|---|---|
| | [Li_{2-2z}M₂ₓA_{2y}]O | M | A | x | y | z | x/(x + y) | (1 − z + x) |
| Comparative | Li_{1.5}Co_{0.25}O | Co | — | 0.125 | 0 | 0.25 | 1 | 0.143 |
| Example 3 | | | | | | | | |
| Example 6 | Li_{1.45}Co_{0.2}Al_{0.05}O | Co | Al | 0.1 | 0.025 | 0.275 | 0.8 | 0.121 |
| Example 2 | Li_{1.375}Co_{0.125}Al_{0.125}O | Co | Al | 0.0625 | 0.0625 | 0.3125 | 0.5 | 0.083 |
| Comparative | Li_{1.3}Co_{0.05}Al_{0.2}O | Co | Al | 0.025 | 0.1 | 0.35 | 0.2 | 0.037 |
| Example 4 | | | | | | | | |
| Comparative | Li_{1.25}Al_{0.25}O | — | Al | 0 | 0.125 | 0.375 | 0 | 0 |
| Example 5 | | | | | | | | |

| | | | | Average | |
|---|---|---|---|---|---|
| | (x + y)/ | Amount of | Discharge | discharge | Discharge |
| | (1 − | charge | capacity | potential | energy density |
| | z + x + y) | mAh/g | mAh/g | V (vs. Li/Li⁺) | mWh/g |
| Comparative | 0.143 | 350 | 350 | 2.37 | 829 |
| Example 3 | | 350 | 350 | | |
| Example 6 | 0.147 | 350 | 310 | 2.437 | 853 |
| Example 2 | 0.154 | 264 | 77 | 2.552 | 792 |
| Comparative | 0.161 | | | 2.295 | 176 |
| Example 4 | | 0.2 | 67 | | |
| Comparative | 0.200 | | | 2.356 | 157 |
| Example 5 | | | | | |

As shown in Table 2, it can be seen that Examples 1 to 5 containing a predetermined amount of the typical element A have a high average discharge potential. On the other hand, it can be seen that Comparative Example 1 not containing the typical element A and Comparative Example 2 containing Zn in place of the typical element A do not have a high average discharge potential.

As shown in Table 3, it can be seen that the average discharge potential is increased by increasing the ratio x/(x+y), representing a content ratio of the transition metal element M to a sum of the transition metal element M and the typical element A, to be more than 0.2. It can be seen that the average discharge potential is particularly high when the ratio x/(x+y) is around 0.5. As shown in Table 4, it can be seen that the discharge capacity and the discharge energy density tend to be higher when the ratio x/(x+y) is relatively high.

In the above Examples, in the preparation of the positive electrode, the step of performing the mixing treatment with the ball mill on the mixture of the positive active material and the acetylene black as the conductive agent was provided. Here, an experiment was conducted to confirm an effect of performing the mixing treatment with the ball mill on the mixture of the positive active material and the conductive agent in the preparation of the positive electrode.

### Example 71

0.75 g of the positive active material (Li_{1.389}Co_{0.139}Al_{0.111}O) of Example 1 and 0.20 g of Ketjenblack were mixed under an argon atmosphere, and placed in a WC pot having an inner volume of 80 mL and containing 250 g of WC balls having a diameter of 5 mm, and the pot was closed with a lid. The pot was set in a planetary ball mill (“pulverisette 5” from FRITSCH) and dry-pulverized at a revolution speed of 200 rpm for 30 minutes to prepare a mixed powder of the positive active material and Ketjen black.

95 parts by mass of the mixed powder and 5 parts by mass of polytetrafluoroethylene powder were kneaded in an agate mortar and molded into a sheet shape. The obtained sheet was punched into a disk shape with a diameter of 12 mmφ to prepare a positive electrode sheet with a mass of about 0.03 g. The positive electrode sheet was pressure-bonded to a current collector (diameter 21 mmφ) made of aluminum mesh to obtain a positive electrode of Example 7.

### Comparative Example 61

A positive electrode of Comparative Example 6 was obtained in the same manner as in Example 6 except that a mixed powder of the positive active material and Ketjen black was prepared by sufficiently mixing 0.75 g of the positive active material (Li_{1.389}Co_{0.139}Al_{0.111}O) of Example 1 and 0.20 g of Ketjenblack in an agate mortar under an argon atmosphere.

### Comparative Example 7

A positive electrode of Comparative Example 7 was obtained in the same manner as in Example 7 except that the positive active material (Li_{1.5}Co_{0.25}O) of Comparative Example 1 was used.

### Comparative Example 8

A positive electrode of Comparative Example 8 was obtained in the same manner as in Comparative Example 6 except that the positive active material (Li_{1.5}Co_{0.25}O) of Comparative Example 1 was used.

### (Production of Nonaqueous Electrolyte Energy Storage Device (Evaluation Cell))

The positive electrode of Example 7 and Comparative Examples 6 to 8 were used, lithium metal having a diameter of 22 mmφ was used as the negative electrode, the electrodes were stacked with a polypropylene separator interposed therebetween, and 300 μL of nonaqueous electrolyte of the same composition as the nonaqueous electrolyte used in Example 1 was applied to configure an evaluation cell (energy storage device). The evaluation cell was produced under an argon atmosphere.

### (Charge-Discharge Test)

With respect to the evaluation cells obtained using the respective positive electrodes of Example 7 and Comparative Examples 6 to 8, a charge-discharge test of 10 cycles was performed in a 25° C. temperature environment in a glove box under an argon atmosphere. A current density was set to 50 mA/g per mass of the positive active material contained in the positive electrode, and constant current (CC) charge-discharge was performed. The charge-discharge test started with charging, and the charge was terminated when the electric amount reached 300 mAh/g which was the upper limit or the potential reached 4.5 V (vs. Li/Li⁺) which was the upper limit. The discharge was terminated when the potential reached 1.5 V (vs. Li/Li⁺) which was the lower limit. Table 5 shows the discharge capacity at the tenth cycle.

TABLE 5

| | | | | Discharge |
|---|---|---|---|---|
| | | | | capacity at |
| | Positive active material | Conductive | Mixing | 10th cycle |
| | [Li_{2-2z}M₂ₓA_{2y}]O | material | method | (mAh/g) |
| Example 7 | Li₁₃₈₉Co_{0.139}Al_{0.111}O | Ketjen black | Ball mill | 293 |
| | (Example 1) | | (WC) | |
| Comparative | | | Mortar | 75 |
| Example 6 | | | | |
| Comparative | Li_{1.5}Co_{0.25}O | | Ball mill | 286 |
| Example 7 | (Comparative Example 1) | | (WC) | |
| Comparative | | | Mortar | 278 |
| Example 8 | | | | |

As can be seen from Table 5, the method of producing a positive electrode including mechanically milling a mixture containing a positive active material and a conductive agent exhibits a remarkable effect in that a positive electrode capable of providing a nonaqueous electrolyte energy storage device having sufficient discharge performance can be provided by applying this production method to the positive active material of the present invention. However, this mechanism of action is not clear.

In order to estimate this action mechanism, the present inventor performed an X-ray diffraction measurement on each of the positive electrodes taken out from the nonaqueous electrolyte energy storage devices of Example 7 and Comparative Example 6 after the charge-discharge test. Table 6 shows crystallite sizes obtained from a peak near 33° and a peak near 56° from the obtained X-ray diffraction diagram.

TABLE 6

| | | | Crystallite | Crystallite |
|---|---|---|---|---|
| | | | size | size |
| | Positive active material | Mixing | (33°) | (56°) |
| | [Li_{2-2z}M₂ₓA_{2y}]O | method | \acute{Å} | \acute{Å} |
| Positive | Li_{1.389}Co_{0.139}Al_{0.111}O | Ball mill | 75 | 55 |
| electrode of | (Example 1) | (WC) | | |
| Example 7 | | | | |
| Positive | | Mortar | 75 | 57 |
| electrode of | | | | |
| Comparative | | | | |
| Example 6 | | | | |

As seen in Table 6, the crystallite sizes of the positive active material were about the same regardless of whether or not the mixture containing the positive active material and the conductive agent of the present invention was mechanically milled. From this, it is suggested that the effect of obtaining a sufficient discharge capacity by mechanically milling the mixture containing the positive active material and the conductive agent of the present invention is not due to a change in the crystallite size of the positive active material.

The present inventor presumes the following with regard to the above mechanism of action. In a general mixing method using an agate mortar or the like, a mixture in which the positive active material contacts the conductive agent only with bulk surfaces is obtained. On the other hand, it is considered that since pulverization and agglomeration of particles are repeated at a nano level by the mechanical milling treatment using a ball mill device or the like, a composite in a state in which the conductive agent is incorporated in a bulk phase of the positive active material is formed. In the positive active material of Example 1 used in Example 7 and Comparative Example 6, the Co concentration in the positive active material is lower than that of the positive active material of Comparative Example 1 used in Comparative Examples 7 and 8, so that conductivity is poor. Therefore, the behavior of the positive electrode using such a positive active material largely depends on a composite form with the conductive agent. Thus, while the positive electrode of Comparative Example 6 using a general mixing method is likely to cause overvoltage, the positive electrode of Example 7 in which a good composite form of the positive active material and the conductive agent is formed by the mechanical milling treatment is considered to have shown excellent performance.

### INDUSTRIAL APPLICABILITY

The present invention can be applied to nonaqueous electrolyte energy storage devices to be used as power sources for electronic devices such as personal computers and communication terminals, automobiles and the like, and electrodes, positive active materials, and the like included in the nonaqueous electrolyte energy storage device.

### DESCRIPTION OF REFERENCE SIGNS

1: Nonaqueous electrolyte energy storage device
2: Electrode assembly
3: Battery case
4: Positive electrode terminal
4′: Positive electrode lead
5: Negative electrode terminal
5′: Negative electrode lead
20: Energy storage unit
30: Energy storage apparatus

1. A positive active material comprising an oxide represented by the following formula (1):
[Li_{2-2z}M₂ₓA_{2y}]O (1)
wherein M is Co, Fe, Cu, Mn, Ni, Cr or a combination thereof, A is a group 13 element, a group 14 element, P, Sb, Bi, Te, or a combination thereof, and x, y and z satisfy the following formulas (a) to (d):
0<x<1 (a)
0<y<1 (b)
x+y≤z<1 (c)
0.2<x/(x+y) (d).

2. The positive active material according to claim 1, wherein the oxide has a crystal structure belonging to an inverse fluorite structure.

3. The positive active material according to claim 1, wherein x and z in the formula (1) satisfy the following formula (e):
0.01≤x/(1−z+x)≤0.2 (e).

4. A positive active material comprising an oxide containing lithium, a transition metal element M, and a typical element A,
wherein the transition metal element M is Co, Fe, Cu, Mn, Ni, Cr or a combination thereof,
the typical element A is a group 13 element, a group 14 element, P, Sb, Bi, Te or a combination thereof,
a molar ratio (M/(M+A)) of a content of the transition metal element M to a total content of the transition metal element M and the typical element A in the oxide is more than 0.2, and
the oxide has a crystal structure belonging to an inverse fluorite structure.

5. The positive active material according to claim 1, wherein in an X-ray diffraction diagram of the oxide, a full width at half maximum of a diffraction peak near a diffraction angle 2θ=33° is 0.3° or more.

6. A positive electrode for a nonaqueous electrolyte energy storage device, comprising the positive active material according to claim 1.

7. A nonaqueous electrolyte energy storage device, comprising the positive electrode according to claim 6.

8. A method of producing a positive active material, comprising treating a material, containing a transition metal element M and a typical element A, by a mechanochemical method,
wherein the material contains a lithium transition metal oxide containing the transition metal element M and a compound containing the typical element A, or contains a lithium transition metal oxide containing the transition metal element M and the typical element A,
the transition metal element M is Co, Fe, Cu, Mn, Ni, Cr or a combination thereof,
the typical element A is a group 13 element, a group 14 element, P, Sb, Bi, Te or a combination thereof, and
a molar ratio (M/(M+A)) of a content of the transition metal element M to a total content of the transition metal element M and the typical element A in the material is more than 0.2.

9. A method of producing a positive electrode for a nonaqueous electrolyte energy storage device, comprising producing a positive electrode using a positive active material according to claim 1.

10. A method of producing a positive electrode for a nonaqueous electrolyte energy storage device, comprising mechanically milling a mixture containing the positive active material according to claim 1 and a conductive agent.

11. A method of producing a nonaqueous electrolyte energy storage device, comprising a positive electrode produced by the method of producing a positive electrode for a nonaqueous electrolyte energy storage device according to claim 9.

12. The positive active material according to claim 3, wherein in an X-ray diffraction diagram of the oxide, a full width at half maximum of a diffraction peak near a diffraction angle 2θ=33° is 0.3° or more.

13. A positive electrode for a nonaqueous electrolyte energy storage device, comprising the positive active material according to claim 3.

14. A nonaqueous electrolyte energy storage device, comprising the positive electrode according to claim 13.

15. A method of producing a positive electrode for a nonaqueous electrolyte energy storage device, comprising producing a positive electrode using a positive active material according to claim 3.

16. A method of producing a positive electrode for a nonaqueous electrolyte energy storage device, comprising producing a positive electrode using a positive active material obtained by the method of producing a positive active material according to claim 8.

17. A method of producing a positive electrode for a nonaqueous electrolyte energy storage device, comprising mechanically milling a mixture containing the positive active material according to claim 3 and a conductive agent.

18. A method of producing a nonaqueous electrolyte energy storage device, comprising a positive electrode produced by the method of producing a positive electrode for a nonaqueous electrolyte energy storage device according to claim 15.

19. A method of producing a nonaqueous electrolyte energy storage device, comprising a positive electrode produced by the method of producing a positive electrode for a nonaqueous electrolyte energy storage device according to claim 16.
